(19) United States
(12) Patent Application Publication
(10) Pub. No.: US 2024/0169844 A1
(43) Pub. Date: May 23, 2024

(54) METHODS AND SYSTEMS FOR ENHANCED FLIGHT MANAGEMENT SERVICES USING NON-STANDARD DATABASES

(71) Applicant: HONEYWELL INTERNATIONAL s.r.o., Prague (CZ)

(72) Inventors: Muthusankar Subramaniyan, Brno (CZ); Stepan Dopita, Brno (CZ); Zdenek Jancik, Brno (CZ)

(73) Assignee: HONEYWELL INTERNATIONAL s.r.o., Prague (CZ)

(21) Appl. No.: 18/160,376

(22) Filed: Jan. 27, 2023

(30) Foreign Application Priority Data
Nov. 21, 2022 (IN) 202211066715

(51) Int. Cl. G08G 5/00; G06F 16/28

(52) U.S. Cl. CPC G08G 5/0021; G06F 16/284

(57) ABSTRACT

Systems and methods are provided for providing flight management services with non-standard databases. The system has a flight management system (FMS) for an aircraft that calculates flight management services for the aircraft. Also included is a standard avionics database onboard the aircraft that provides data to the FMS for the calculation of flight management services for the aircraft. A non-standard avionics database is located external to the FMS that is a dynamic linked library (DLL) which provides enhanced supplemental data to the FMS for the calculation of flight management services for the aircraft.

### STATEMENT REGARDING GOVERNMENT SPONSORED RESEARCH OR DEVELOPMENT

This invention was made with Government support under Grant Agreement No. 807097 awarded by Clean Sky 2 Joint Undertaking under the European Union's Horizon 2020 Research and Innovation Programme. The Government has certain rights in this invention.

### CROSS-REFERENCE TO RELATED APPLICATION(S)

This application claims priority from Indian Provisional Patent Application No. 202211066715, titled “METHODS AND SYSTEMS FOR ENHANCED FLIGHT MANAGEMENT SERVICES USING NON-STANDARD DATABASES” that was filed Nov. 21, 2022.

### TECHNICAL FIELD

The present invention generally relates to flight management operations, and more particularly relates to usage of enhanced flight management services using non-standard databases.

### BACKGROUND

Flight management software helps aircraft to perform flight planning, navigation, performance prediction aircraft guidance and datalink services. Each of these functions are computed from several standard databases like Navigation databases, Aircraft Engine databases, Magnetic Variation databases, Air Traffic Control databases, etc. Some these databases are separately loadable to aircraft, as it can be few updates or upgrade based on aircraft and engine configurations. However, these databases may be non-standardized. Hence, there is a need for a system and method for providing enhanced flight management services using non-standard databases.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A system is provided for providing flight management services with non-standard databases. The system comprises: a flight management system (FMS) for an aircraft, where the FMS calculates flight management services for the aircraft; a standard avionics database located onboard the aircraft, where the standard avionics database provides data to the FMS for the calculation of flight management services for the aircraft; and a non-standard avionics database located external to the FMS, where the non-standard avionics database comprises a dynamic linked library (DLL) that provides enhanced supplemental data to the FMS for the calculation of flight management services for the aircraft.

A method is provided for providing flight management services with non-standard databases. The method comprises: accessing a flight management system (FMS) for an aircraft, where the FMS calculates flight management services for the aircraft; retrieving data for the FMS for the calculation of flight management services for the aircraft from a standard avionics database located onboard the aircraft; retrieving data for the FMS for the calculation of flight management services for the aircraft from a non-standard avionics database located external to the FMS, where the non-standard avionics database comprises a dynamic linked library (DLL) that provides enhanced supplemental data to the FMS for the calculation of flight management services for the aircraft; and providing the calculated flight management services to the aircraft via the FMS.

Furthermore, other desirable features and characteristics of the method and system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a diagram of an in-flight aircraft 102 that contains an onboard flight management system (FMS) along with a visual data system in accordance with one embodiment;

FIG. 2 depicts a diagram of an aircraft system suitable for implementation onboard an aircraft shown previously in FIG. 1 in accordance with one embodiment;

FIG. 3A depicts a block diagram of a prior art database relationship to FMS functions in accordance with one embodiment;

FIG. 3B depicts a block diagram of a database relationship to FMS functions with an intermediary enhanced dynamic link library (DLL) database in accordance with one embodiment;

FIG. 4 shows a block diagram of an example of Next Generation Flight Management System (NGFMS) software architecture related to trajectory prediction computation in accordance with one embodiment;

FIG. 5 shows a block diagram of an example of an NGFMS an aircraft performance model in accordance with one embodiment;

FIG. 6 shows a block diagram of an example of a Flight Management Engine (FME) for an aircraft performance model in accordance with one embodiment; and

FIG. 7 shows a flowchart of a method for providing flight management services with non-standard databases in accordance with one embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

Embodiments of the subject matter described herein relate to an existing module integrated, incorporated, or otherwise instantiated for interoperability and use with other existing components of the vehicle system. For purposes of explanation, the subject matter is described herein primarily in the context of aircraft, however, the subject matter is not necessarily limited to use with aircraft and may be implemented in an equivalent manner for other types vehicles (e.g., automotive vehicles, marine vessels, or the like).

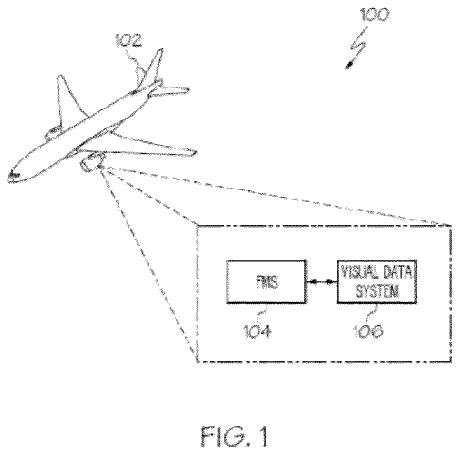

Turning now to FIG. 1, a diagram 100 is shown of an in-flight aircraft 102 that contains an onboard flight management system (FMS) 104 along with a visual data system 106 that is accessed by the FMS 104 in accordance with one embodiment. In alternative embodiments, the visual data system 106 may be integrated as part of the FMS 104. The FMS 104, as is generally known, is a specialized computer that automates a variety of in-flight tasks such as in-flight management of the flight plan. Using various sensors such as global positioning system (GPS), the FMS 104 determines the aircraft's position and guides the aircraft along its flight plan using its navigation database. From the cockpit, the FMS 104 is normally controlled through a visual display device such as a control display unit (CDU) which incorporates a small screen, a keyboard or a touchscreen. The FMS 104 displays the flight plan and other critical flight data to the aircrew during operation.

The FMS 104 may have a built-in electronic memory system that contains a navigation database. The navigation database contains elements used for constructing a flight plan. In some embodiments, the navigation database may be separate from the FMS 104 and located onboard the aircraft while in other embodiments the navigation database may be located on the ground and relevant data provided to the FMS 104 via a (non-illustrated) communications link with a (non-illustrated) ground station. The navigation database used by the FMS 104 may typically include: waypoints/intersections; airways; radio navigation aids/navigation beacons; airports; runway; standard instrument departure (SID) information; standard terminal arrival (STAR) information; holding patterns; and instrument approach procedures. Additionally, other waypoints may also be manually defined by pilots along the route.

The flight plan is generally determined on the ground before departure by either the pilot or a dispatcher for the owner of the aircraft. It may be manually entered into the FMS 104 or selected from a library of common routes. In other embodiments the flight plan may be loaded via a communications data link from an airline dispatch center. During preflight planning, additional relevant aircraft performance data may be entered including information such as: gross aircraft weight; fuel weight and the center of gravity of the aircraft. The aircrew may use the FMS 104 to modify the plight flight plan before takeoff or even while in flight for variety of reasons. Such changes may be entered via the CDU. Once in flight, the principal task of the FMS 104 is to accurately monitor the aircraft's position. This may use a GPS, a VHF omnidirectional range (VOR) system, or other similar sensor in order to determine and validate the aircraft's exact position. The FMS 104 constantly cross checks among various sensors to determine the aircraft's position with accuracy.

Additionally, the FMS 104 may be used to perform advanced vertical navigation (VNAV) functions. The purpose of VNAV is to predict and optimize the vertical path of the aircraft. The FMS 104 provides guidance that includes control of the pitch axis and of the throttle of the aircraft. In order to accomplish these tasks, the FMS 104 has detailed flight and engine model data of the aircraft. Using this information, the FMS 104 may build a predicted vertical descent path for the aircraft. A correct and accurate implementation of VNAV has significant advantages in fuel savings and on-time efficiency.

In exemplary embodiments, an existing flight management computer (FMC) (or flight management system (FMS)) onboard an aircraft is utilized to communicate data between existing onboard avionics systems or line-replaceable units (LRUs) and another module coupled to the FMC, which supports or otherwise performs new flight management functionality that is not performed by the FMC. For example, a multifunction control and display unit (MCDU) may support or otherwise perform new flight management functionality based on data from onboard avionics or LRUs received via the FMC. In this regard, the FMC is configured to receive operational or status data from one or more avionics systems or LRUs onboard the aircraft at corresponding avionics interfaces and convert one or more characteristics of the operational data to support communicating the operational data with the MCDU. For purposes of explanation, the subject matter may primarily be described herein in the context of converting operational data received from onboard avionics or LRUs in a first format (e.g., an avionics bus format) into another format supported by the interface with the MCDU, the subject matter described herein is not necessarily limited to format conversions or digital reformatting, and may be implemented in an equivalent manner for converting between other data characteristics, such as, for example, different data rates, throughputs or bandwidths, different sampling rates, different resolutions, different data compression ratios, and the like. Additionally, the FMC may be configured to receive data from sources external to the aircraft such as ground-based databases, third-party databases, etc.

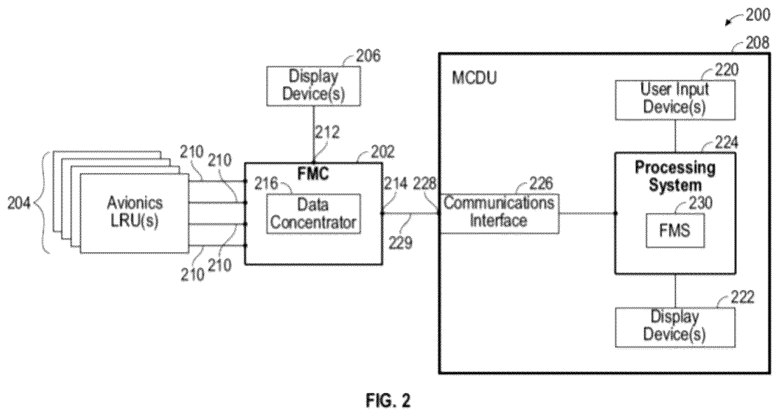

FIG. 2 depicts an exemplary embodiment of an aircraft system 200 suitable for implementation onboard an aircraft 102 shown previously in FIG. 1. The illustrated aircraft system 200 includes a flight management computing module 202 communicatively coupled to a plurality of onboard avionics LRUs 204, one or more display devices 206, and a multifunction computing module 208. It should be appreciated that FIG. 2 depicts a simplified representation of the aircraft system 200 for purposes of explanation, and FIG. 2 is not intended to limit the subject matter in any way.

The flight management computing module 202 generally represents the FMC, the FMS, or other hardware, circuitry, logic, firmware and/or other components installed onboard the aircraft and configured to perform various tasks, functions and/or operations pertaining to flight management, flight planning, flight guidance, flight envelope protection, four-dimensional trajectory generation or required time of arrival (RTA) management, and the like. Accordingly, for purposes of explanation, but without limiting the functionality performed by or supported at the flight management computing module 202, the flight management computing module 202 may alternatively be referred to herein as the FMC. The FMC 202 includes a plurality of interfaces 210 configured to support communications with the avionics LRUs 204 along with one or more display interfaces 212 configured to support coupling one or more display devices 206 to the FMC 202. In the illustrated embodiment, the FMC 202 also includes a communications interface 214 that supports coupling the multifunction computing module 208 to the FMC 202.

The FMC 202 generally includes a processing system designed to perform flight management functions, and potentially other functions pertaining to flight planning, flight guidance, flight envelope protection, and the like. Depending on the embodiment, the processing system could be realized as or otherwise include one or more processors, controllers, application specific integrated circuits, programmable logic devices, discrete gate or transistor logics, discrete hardware components, or any combination thereof. The processing system of the FMC 202 generally includes or otherwise accesses a data storage element (or memory), which may be realized as any sort of non-transitory short or long term storage media capable of storing programming instructions for execution by the processing system of the FMC 202. In exemplary embodiments, the data storage element stores or otherwise maintains code or other computer-executable programming instructions that, when read and executed by the processing system of the FMC 202, cause the FMC 202 to implement, generate, or otherwise support a data concentrator application 216 that performs certain tasks, operations, functions, and processes described herein.

The avionics LRUs 204 generally represent the electronic components or modules installed onboard the aircraft that support navigation, flight planning, and other aircraft control functions in a conventional manner and/or provide real-time data and/or information regarding the operational status of the aircraft to the FMC 202. For example, practical embodiments of the aircraft system 200 will likely include one or more of the following avionics LRUs 204 suitably configured to support operation of the aircraft: a weather system, an air traffic management system, a radar system, a traffic avoidance system, an autopilot system, an autothrottle (or autothrust) system, a flight control system, hydraulics systems, pneumatics systems, environmental systems, electrical systems, engine systems, trim systems, lighting systems, crew alerting systems, electronic checklist systems, and/or another suitable avionics system.

In exemplary embodiments, the avionics interfaces 210 and other aircraft interface devices (AID) are realized as different ports, terminals, channels, connectors, or the like associated with the FMC 202 that are connected to different avionics LRUs 204 via different wiring, cabling, buses, or the like. In this regard, the interfaces 210 may be configured to support different communications protocols or different data formats corresponding to the respective type of avionics LRU 204 that is connected to a particular interface 210. For example, the FMC 202 may communicate navigation data from a navigation system via a navigation interface 210 coupled to a data bus supporting the ARINC 424 (or A424) standard, the ARINC 629 (or A629) standard, the ARINC 422 (or A422) standard, or the like. As another example, a datalink system or other communications LRU 204 may utilize an ARINC 619 (or A619) compatible avionics bus interface for communicating datalink communications or other communications data with the FMC 202.

The display device(s) 206 generally represent the electronic displays installed onboard the aircraft in the cockpit, and depending on the embodiment, could be realized as one or more monitors, screens, liquid crystal displays (LCDs), a light emitting diode (LED) displays, or any other suitable electronic display(s) capable of graphically displaying data and/or information provided by the FMC 202 via the display interface(s) 212. Similar to the avionics interfaces 210, the display interfaces 212 are realized as different ports, terminals, channels, connectors, or the like associated with the FMC 202 that are connected to different cockpit displays 206 via corresponding wiring, cabling, buses, or the like. In one or more embodiments, the display interfaces 212 are configured to support communications in accordance with the ARINC 661 (or A661) standard. In one embodiment, the FMC 202 communicates with a lateral map display device 206 using the ARINC 702 (or A702) standard.

In exemplary embodiments, the multifunction computing module 208 is realized as a multifunction control and display unit (MCDU) that includes one or more user interfaces, such as one or more input devices 220 and/or one or more display devices 222 (shown previously as 106 in FIG. 1), a processing system 224, and a communications module 226. The MCDU 208 generally includes at least one user input device 220 that is coupled to the processing system 224 and capable of receiving inputs from a user, such as, for example, a keyboard, a key pad, a mouse, a joystick, a directional pad, a touchscreen, a touch panel, a motion sensor, or any other suitable user input device or combinations thereof. The display device(s) 222 may be realized as any sort of monitor, screen, LCD, LED display, or other suitable electronic display capable of graphically displaying data and/or information under control of the processing system 224.

The processing system 224 generally represents the hardware, circuitry, logic, firmware and/or other components of the MCDU 208 configured to perform the various tasks, operations, functions and/or operations described herein. Depending on the embodiment, the processing system 224 may be implemented or realized with a general purpose processor, a microprocessor, a controller, a microcontroller, a state machine, an application specific integrated circuit, a field programmable gate array, any suitable programmable logic device, discrete gate or transistor logic, discrete hardware components, or any combination thereof, designed to perform the functions described herein. Furthermore, the steps of a method or algorithm described in connection with the embodiments disclosed herein may be embodied directly in hardware, in firmware, in a software module executed by the processing system 224, or in any practical combination thereof. In this regard, the processing system 224 includes or accesses a data storage element (or memory), which may be realized using any sort of non-transitory short or long term storage media, and which is capable of storing code or other programming instructions for execution by the processing system 224. In exemplary embodiments described herein, the code or other computer-executable programming instructions, when read and executed by the processing system 224, cause the processing system 224 to implement with an FMS 230 (shown previously as 104 in FIG. 1) additional tasks, operations, functions, and processes described herein.

The communications module 226 generally represents the hardware, module, circuitry, software, firmware and/or combination thereof that is coupled between the processing system 224 and a communications interface 228 of the MCDU 208 and configured to support communications between the MCDU 208 and the FMC 202 via an electrical connection 229 between the MCDU communications interface 228 and the FMC communications interface 214. For example, in one embodiment, the communications module 226 is realized as an Ethernet card or adapter configured to support communications between the FMC 202 and the MCDU 208 via an Ethernet cable 229 provided between Ethernet ports 214, 228. In other embodiments, the communications module 226 is configured to support communications between the FMC 202 and the MCDU 208 in accordance with the ARINC 429 (A429) standard via an A429 data bus 229 provided between A429 ports 214, 228 of the respective modules 202, 208. In yet other embodiments, the communications module 226 is configured to support communications between the FMC 202 and the MCDU 208 in accordance with the ARINC 422 (A422) standard via an A422 data bus 229 provided between A422 ports 214, 228 of the respective modules 202, 208. In yet other embodiments, the communications module 226 is configured to support communications between the FMC 202 and the MCDU 208 in accordance with the ARINC 739 (A739) standard via an A739 data bus 229 provided between A739 ports 214, 228 of the respective modules 202, 208.

In various embodiments, the FMC 202 and MCDU 208 communicate using a different communications protocol or standard than one or more of the avionics LRUs 204 and/or the display devices 206. In such embodiments, to support communications of data between the MCDU 208 and those LRUs 204 and/or display devices 206, the data concentrator application 216 at the FMC 202 converts data from one format to another before retransmitting or relaying that data to its destination. For example, the data concentrator application 216 may convert data received from an avionics LRU 204 to the A429 or Ethernet format before providing the data to the MCDU 208, and vice versa. Additionally, in exemplary embodiments, the FMC 202 validates the data received from an avionics LRU 204 before transmitting the data to the MCDU 208. For example, the FMC 202 may perform debouncing, filtering, and range checking, and/or the like prior to converting and retransmitting data from an avionics LRU 204.

It should be noted that although the subject matter may be described herein in the context of the multifunction computing module 208 being realized as an MCDU, in alternative embodiments, the multifunction computing module 208 could be realized as an electronic flight bag (EFB) or other mobile or portable electronic device. In such embodiments, an EFB capable of supporting an FMS 230 application may be connected to an onboard FMC 202 using an Ethernet cable 229 to support flight management functionality from the EFB in an equivalent manner as described herein in the context of the MCDU.

In one or more embodiments, the MCDU 208 stores or otherwise maintains programming instructions, code, or other data for programming the FMC 202 and transmits or otherwise provides the programming instructions to the FMC 202 to update or otherwise modify the FMC 202 to implement the data concentrator application 216. For example, in some embodiments, upon establishment of the connection 229 between modules 202, 208, the MCDU 208 may automatically interact with the FMC 202 and transmit or otherwise provide the programming instructions to the FMC 202, which, in turn, executes the instructions to implement the data concentrator application 216. In some embodiments, the data concentrator application 216 may be implemented in lieu of flight management functionality by the MCDU 208 reprogramming the FMC 202. In other embodiments, the FMC 202 may support the data concentrator application 216 in parallel with flight management functions. In this regard, the FMC 202 may perform flight management functions, while the FMS 230 application on the MCDU 208 supplements the flight management functions to provide upgraded flight management functionality within the aircraft system 200.

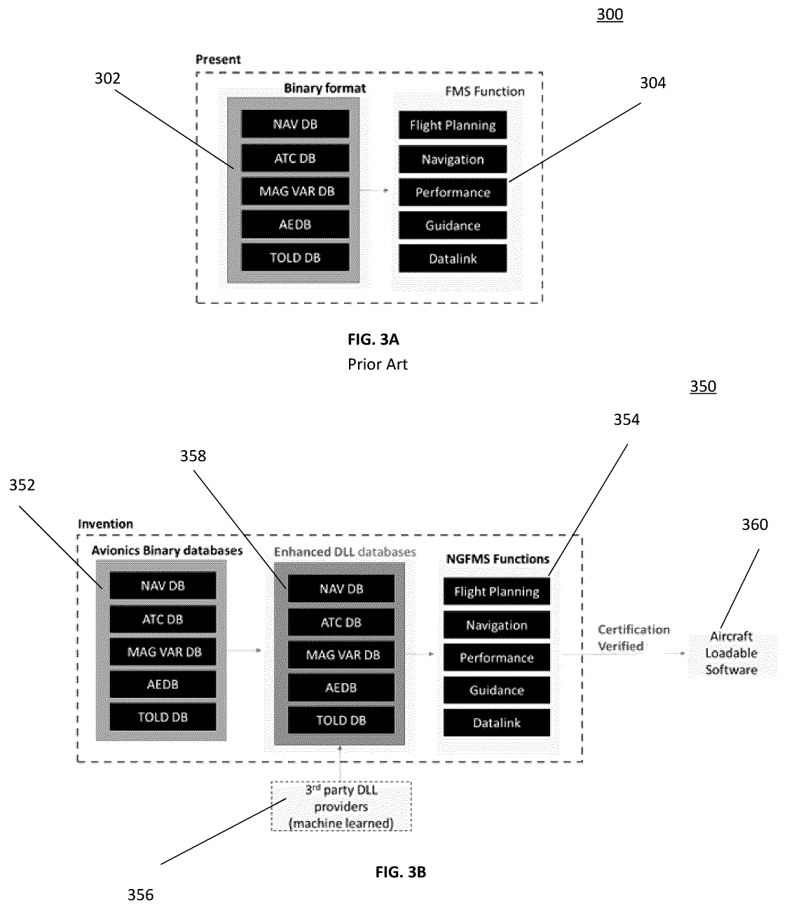

Turning now to FIG. 3A, a block diagram 300 is shown of a prior art database relationship to FMS functions in accordance with one embodiment. Flight management software helps aircraft to perform functions 304 such as flight planning, navigation, performance prediction aircraft guidance and datalink services. Each of these functions are computed from several standard databases 302 like Navigation Databases (NAV DB), Aircraft Engine Databases (AEDB), Magnetic Variation Databases (MAG VAR DB), Air Traffic Control Databases (ATC DB), Takeoff and Landing Databases (TOLD DB), etc. The databases are typically in a “binary data format” or “binary format”.

A “binary” file is a file whose content is in a binary format consisting of a series of sequential bytes, each of which is eight bits in length. The content must be interpreted by a program or a hardware processor (i.e., the file is not human-readable) that understands in advance exactly how that content is formatted and how to read the data. Binary files may include a wide range of file types, including executables, libraries, graphics, databases, archives, etc.

Turning now to FIG. 3B, a block diagram 350 is shown of an avionics binary format databases 352 (similar to 302 in FIG. 1) as they relate to FMS functions 354 (similar to 304 in FIG. 1) with an intermediary enhanced dynamic link library (DLL) databases 358 to produce aircraft loadable software 360 in accordance with one embodiment. The embodiment shown uses Next Generation Flight Management Services (NGFMS) for achieving an improved and enhanced service options using a third party customizable and improved data to dynamic link library (DLL) 356 on top of a standard avionics databases 352 which are in a binary data format. This is a unique approach because a flight management software function uses a certified standard binary database for its calculations. As a result, NGFMS can be operated with a non-standard DLL database for running its high-fidelity software.

A DLL database is a library that contains code and data that can be used by more than one program at the same time. For example, in Windows operating systems, the Comdlg32 DLL performs common dialog box related functions. Each program can use the functionality that is contained in this DLL to implement an open dialog box. This helps promote code reuse and efficient memory usage. By using a DLL, a program can be modularized into separate components. When these changes are isolated to a DLL, you can apply an update without needing to build or install the whole program again.

Some of the advantages that are provided when a program uses a DLL include: using fewer resources; promoting modular architecture; and ease of deployment and installation. For example, when multiple programs use the same library of functions, a DLL can reduce the duplication of code that is loaded on the disk and in physical memory. It can greatly influence the performance of not just the program that is running in the foreground, but also other programs that are running on the Windows operating system. Also, a DLL helps promote developing modular programs. It helps you develop large programs that require multiple language versions or a program that requires modular architecture. An example of a modular program is an accounting program that has many modules that can be dynamically loaded at run time. Finally, when a function within a DLL needs an update or a fix, the deployment and installation of the DLL does not require the program to be relinked with the DLL. Additionally, if multiple programs use the same DLL, the multiple programs will all benefit from the update or the fix. This issue may more frequently occur when you use a third-party DLL that is regularly updated or fixed.

In some embodiments of the present invention, the DLL is built by a machine learning algorithm. “Machine learning” is an application that enables systems to learn and improve from experience without being explicitly programmed. Machine learning focuses on developing software that can access data and use it to learn for themselves. The machine learning process begins with observations or data, such as examples, direct experience or instruction. The system looks for patterns in data so it can later make inferences based on the examples provided. The primary aim is to allow systems to learn autonomously without human intervention or assistance and adjust actions accordingly.

Machine learning employs various approaches to teach systems to accomplish tasks where no fully satisfactory algorithm is available. A core objective is to generalize from experience. Generalization in this context is the ability of a learning machine to perform accurately on new, unseen examples/tasks after having experienced a learning data set. The training examples come from some generally unknown probability distribution (considered representative of the space of occurrences) and the system has to build a general model about this space that enables it to produce sufficiently accurate predictions in new cases. Because training sets are finite and the future is uncertain, learning theory usually does not yield guarantees of the performance of algorithms. Instead, probabilistic bounds on the performance are typically used.

The present binary format databases are topped up with an intermediary customized enhanced DLL databases to perform an improved FMS planning and predictions. With existing NGFMS software, interfacing an external performance library to a AEDB (Aero Engine Database model) to generate an outcome of improved performance predictions. Additionally, the scope may be widened to include all databases (ATC, TOLD, MARGVAR, NAV, etc.) via improved DLL integration with NGFMS Software for efficient FMS service business options. Consequently, the use of DLLs helps promote modularization of code, code reuse, efficient memory usage, and reduced disk space. So that the operating system and the programs load faster, run faster, and take less disk space on the computer.

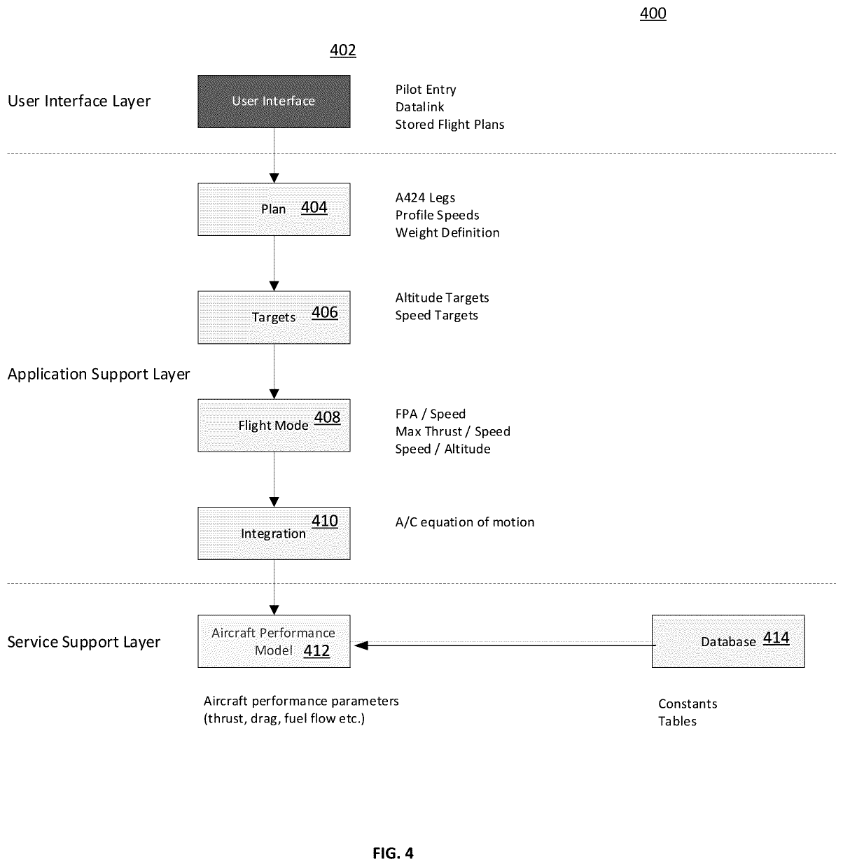

Turning now to FIG. 4, a block diagram 400 is shown of an example of NGFMS software architecture related to trajectory prediction computation in accordance with one embodiment. First, a user interface layer contains a User Interface 402 is provided that allows user actions to modify a flight plan. The actions may include pilot manual entry, a datalink for downloading data, stored flight plans and/or modifications. In the application support layer, the Plan 404 section is used to store flight plan legs, procedures, profile speeds, weight definitions, etc. The Targets 406 are determined from the Plan 404 by applying constraints, limits, etc. The Flight Mode 408 is selected for every segment of the flight plan based on the applicable targets. Examples of the modes include: flight path angle (FPA) speed; max thrust speed; altitude speed; etc. Integration 410 is performed for every segment to apply equations of motion for the aircraft by implementing the selected flight modes. In the service support layer, an Aircraft Performance Model 412 provides performance parameters needed for Integration 410 of the flight plan (thrust, drag, fuel flow, etc.). A Database 414 is used to provide aircraft dependent tables and constants used in the Aircraft Performance Model's 412 parameter computations.

The Aircraft Performance Model 412 (also referred to as “AMS” or “SSL AMS”) is a NG FMS package implementing Aircraft Performance Model, which provides aircraft performance parameters to any other package. It is located in the Support Service Layer (Layer 3) of the NG FMS software architecture. The AMS package is designed so that most of the aircraft variation in performance modeling is implemented inside of the package and all functions above this package can remain same until interface is unchanged. This allows integration of a third-party performance library inside AMS package without affecting rest of the FMS source code.

The AMS package provides aerodynamic computations for an Aero Model, a Propulsion Model, a Performance Model, a Speed Envelope Model, Bleeds Setup Interfaces, a Maximum Operating Speed Interface and a Default Thrust Limit Plan Interface. The Aero Model comprises computations for thrust, drag, minimum maneuver speeds, gross weight at target altitude, stab trim setting, etc. The Propulsion Model comprises of computations for thrust, fuel flow, etc. The Performance Model comprises of computations for the speed envelope, guidance control parameters, optimum altitude, etc. The Speed Envelope Model provides computes the limiting speed envelope values. The Bleeds Setup Interfaces let users know the bleeds settings for different segments in a flight plan. The Maximum Operating Speed Interface let the user know the Maximum operating speeds. The Default Thrust Limit Plan Interface provides access to the plan with a defined thrust limit mode for each in-flight flight phase. The Flaps Slats View let users know the different flaps and slats settings for different configurations.

During usage of the Aircraft Performance Model, the AMS provides or publishes the interfaces to other subsystems so they can communicate with this subsystem. Every published interface has a corresponding interface handle class that is provided by the publisher package. Every user has their own instance of an interface handle for every interface they require. This handle to a specific interface is used to access all the methods inside that interface. Multiple user can bind to the same interface using their own instance of the handle. All the interfaces are published with the parent layer, so that the layer above can bind to it. As long as the SSL AMS package interface is kept the same, it is easy to include additional aircraft performance model or swap implementations. The whole model or some of its part can be also separated into a library.

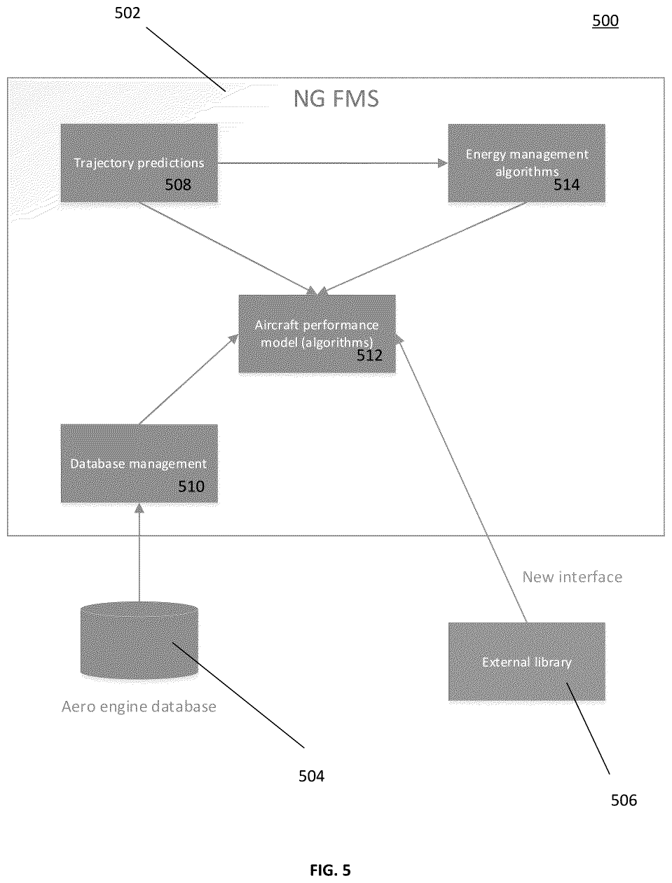

Turning now to FIG. 5, a block diagram 500 is shown of an example of an NGFMS 502 for an aircraft performance model 512 in accordance with one embodiment. The NGFMS 502 accesses an Aero Engine Database (AEDB) 504 with a database manager 510 that provides necessary data to the Aircraft Performance Model 512 for use in the appropriate algorithms. Trajectory predictions 508 and Energy Management Algorithms 514 also feed into the Aircraft Performance Model 512. A link is provided for the external DLL 506 that provides additional input to the Aircraft Performance Model 512.

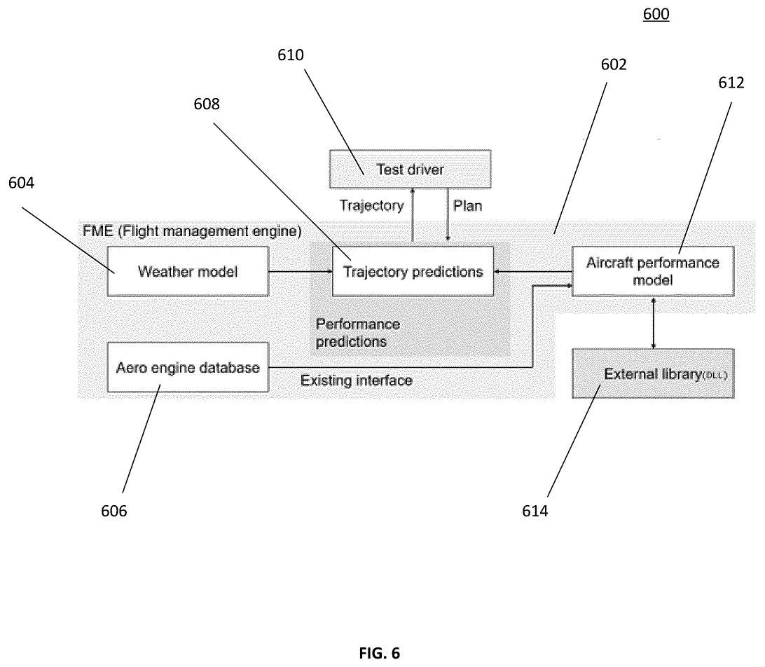

Turning now to FIG. 6, shows a block diagram 600 of an example of a Flight Management Engine (FME) 602 an aircraft performance model 612 in accordance with one embodiment. The FME 602 provides trajectory predictions 608 based on a weather model 604 along with an Aero Engine Database (AEDB) 606 to the aircraft performance model 612 The aircraft performance model 612 is a source of performance parameters for predictions of aircraft performance. The test driver 610 submits a request to the FME's DLL and stores the response into file. A link is provided for the external DLL 614 that provides additional input to the Aircraft Performance Model 612. The FME 602 uses the DLL 614 created from NGFMS source code to compute FMS trajectory predictions.

The operation of the aircraft performance model extension by a third-party library can be split into two phases. The first phase will focus on integration at algorithmic level working at implementation of original equipment manufacturer (OEM) specific wrapper around the library and fitting this wrapper into rest of FMS code. The second phase is the integration of code from first stage with target hardware.

One of the key functions of a flight management system is aircraft trajectory predictions, which are using aircraft performance model to get parameters describing performance of the aircraft. NGFMS software can use different performance models to fulfill needs of different aircraft manufactures. The key factor affecting any energy management algorithm performance is precision of trajectory prediction because all energy management algorithms use trajectory prediction engine to evaluate energy dissipation strategy. The best strategy is then presented to crew. Trajectory prediction accuracy is affected by multiple factors such as weather model precision, aircraft performance model precision or representativeness of aircraft behavior modelling in FMS.

Current aircraft performance model produces data using some algorithms implemented in FMS source code and data stored in different tables of the AEDB. This approach allows the use of certified FMS and database independently and release new AEDB versions without recertifying FMS. The AEDB can also host performance data for multiple aircrafts or fuselage and engine combinations. This configuration is then selected when FMS is installed in aircraft.

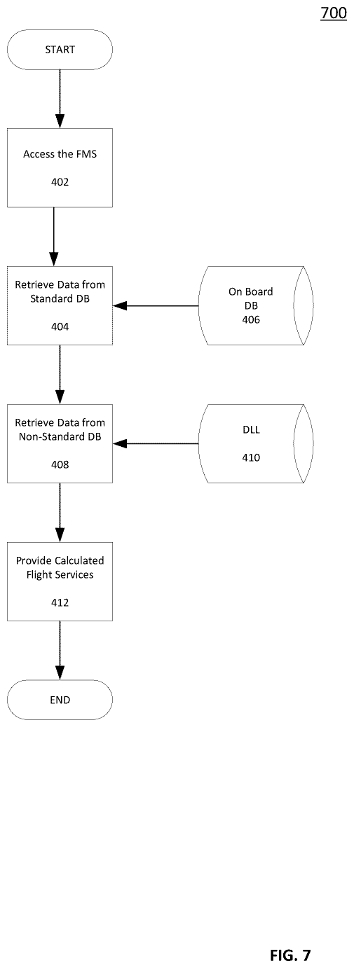

Turning now to FIG. 7, a flowchart 700 is shown of a method for providing flight management services with non-standard databases in accordance with one embodiment. First, the flight management system (FMS) located onboard an aircraft is accessed 402 to calculate flight management services for the aircraft. Data is retrieved for the FMS for the calculation of flight management services from a standard avionics database 406 located onboard the aircraft. In some embodiments, it may not be necessary to retrieve data from the standard database when the DLL is available and provides better data. Enhanced supplemental data is retrieved for the FMS from a non-standard avionics database 410 that comprises a dynamic linked library (DLL). The FMS then calculates the flight management services and provides the results to the aircraft.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set or may be distributed over different locations including over different storage devices, and may exist, at least partially, merely as electronic signals on a system or network.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A system for providing flight management services with non-standard databases, comprising:
a flight management system (FMS) for an aircraft, where the FMS calculates flight management services for the aircraft;
a standard avionics database located onboard the aircraft, where the standard avionics database provides data to the FMS for the calculation of flight management services for the aircraft; and
a non-standard avionics database located external to the FMS, where the non-standard avionics database comprises a dynamic linked library (DLL) that provides enhanced supplemental data to the FMS for the calculation of flight management services for the aircraft.

2. The system of claim 1, where the standard avionics database contains data in a binary format.

3. The system of claim 1, where the non-standard avionics database contains data in a binary format.

4. The system of claim 1, where the non-standard avionics data base is provided by a third party.

5. The system of claim 1, where the standard avionics database comprises a navigation (NAV) database.

6. The system of claim 1, where the standard avionics database comprises an air traffic control (ATC) database.

7. The system of claim 1, where the standard avionics database comprises a magnetic variation (MAG VAR) database.

8. The system of claim 1, where the standard avionics database comprises a aircraft engine (AE) database.

9. The system of claim 1, where the standard avionics database comprises a takeoff and landing (TOLD) database.

10. The system of claim 1, where the DLL was built by a machine learning process.

11. A method for providing flight management services with non-standard databases, comprising:
accessing a flight management system (FMS) located onboard an aircraft, where the FMS calculates flight management services for the aircraft;
retrieving data for the FMS for the calculation of flight management services for the aircraft from a standard avionics database located onboard the aircraft;
retrieving data for the FMS for the calculation of flight management services for the aircraft from a non-standard avionics database located external to the FMS, where the non-standard avionics database comprises a dynamic linked library (DLL) that provides enhanced supplemental data to the FMS for the calculation of flight management services for the aircraft; and
providing the calculated flight management services to the aircraft via the FMS.

12. The method of claim 11, where the standard avionics database contains data in a binary format.

13. The method of claim 11, where the non-standard avionics database contains data in a binary format.

14. The method of claim 11, where the non-standard avionics data base is provided by a third party.

15. The method of claim 11, where the standard avionics database comprises a navigation (NAV) database.

16. The method of claim 11, where the standard avionics database comprises an air traffic control (ATC) database.

17. The method of claim 11, where the standard avionics database comprises a magnetic variation (MAG VAR) database.

18. The method of claim 11, where the standard avionics database comprises a aircraft engine (AE) database.

19. The method of claim 11, where the standard avionics database comprises a takeoff and landing (TOLD) database.

20. The method of claim 11, where the DLL was built by a machine learning process.
